(19) United States
(12) Patent Application Publication
(10) Pub. No.: US 2026/0231866 A1
(43) Pub. Date: Aug. 13, 2026

(54) ADJUSTABLE BALE FORMING CHAMBER SYSTEM

(71) Applicant: Marcrest Manufacturing Inc., Listowel (CA)

(72) Inventor: Keith HORST, Listowel (CA)

(21) Appl. No.: 19/536,585

(22) Filed: Feb. 11, 2026

Related U.S. Application Data
(60) Provisional application No. 63/756,908, filed on Feb. 11, 2025.

(51) Int. Cl. A01F 15/08; A01F 15/07

(52) U.S. Cl. CPC A01F 15/0875; A01F 15/07; A01F 15/071; A01F 15/08; A01F 15/0825

(57) ABSTRACT

An adjustable bale forming chamber that includes a set of controllable interior elements. The interior elements are controlled to apply compression or pressure to at least two sides of a bale that is newly or partially formed.

### CROSS-REFERENCE TO OTHER APPLICATIONS

The disclosure claims priority from U.S. Provisional Patent Application No. 63/756,908 filed Feb. 11, 2025, which is hereby incorporated by reference.

### FIELD

The disclosure is generally directed at agricultural machinery, and more specifically at an adjustable bale forming chamber system.

### BACKGROUND

As is well known in the art, a bale of crop or forage material (e.g., hay) is formed in a baler by compressing the crop material to form the bale into a cube-like shape with predetermined dimensions, and tying twine around the crop material, to hold the bale to the predetermined dimensions. After the bale exits the baler, however, the material in the bale tends to “spring back”, with the result that the bale may ultimately be larger, smaller or have a non-desired density than required. Due to “spring-back”, there may be some irregularity in the sizes of the bales. While the bales are being formed in the chamber, between each compression cycle of the crop material, the material in the bale tends to “spring back”, with the result that the bale dimensions, density, length and weight can vary from time to time.

In the prior art, a conventional exit chamber housing may be positioned on a baler, to receive newly-formed bales therein. In the conventional exit chamber housing, side panels define a gradually tapered channel, i.e., the side panels define a channel in the exit chamber that narrows in a downstream direction, from the front end to the back end of the exit chamber, increasing laterally-exerted compression of the bales as the bales move through the channel. In the prior art, side panels are hinged at the entry end, and have adjustable pressure applied to them. The higher compression of the bale toward the back end of the housing is intended to reduce “spring-back”. However, in practice, the tapered channel tends to exacerbate the extent to which a bale springs back, once the bale exits the conventional exit chamber housing.

Certain aspects of a conventional exit chamber housing are schematically illustrated in FIG. 1, which is a top view of a prior art exit chamber housing 10. The conventional exit chamber housing 10 extends between front and back ends 12, 14 thereof. In the example illustrated in FIG. 1, bales “B₁”, “B₂”, and “B₃” have exited or are exiting from a compression chamber in the baler (not shown) and entered the exit chamber housing 10 at the front end 12, moving through the exit chamber housing 10 in the direction indicated by arrows “A₁”, “A₂”, and “A₃” toward the back end 14. The bales ultimately exit the exit chamber housing 10 at the back end 14. As is well known in the art, the bales are pushed through the exit chamber housing 10 by successive newly-formed bales that are moved from the baler into the front end 12 of the exit chamber housing 10 while the baler is operating. The bale may be partially in the baler chamber and exit chamber when it is completed and tied.

The exit chamber housing 10 includes outer sidewalls 16,18, that define a center line “C” of the exit chamber housing 10 therebetween. As the bales “B₁”, “B₂”, “B₃” move through the exit chamber housing 10, they are guided by interior elements 20, 22 that may generally extend between the front and back ends 12, 14. Adjustment devices 24, 26 (e.g., screws connected to the interior elements 20, 22) may be mounted between the outer sidewalls 16, 18 and the interior elements 20, 22 respectively at locations proximal to the back end 14. The adjustment devices 24, 26 are used to adjust the positions of the interior elements 20, 22 relative to the center line “C” of the exit chamber housing 10. The adjustment devices 24, 26 are schematically represented in FIG. 1 by dashed lines.

As is well known in the art, the adjustment devices 24, 26 are utilized to position the interior elements 20, 22 so as to define a channel 28 from the front end 12 to the back end 14 that may be more or less tapered, as considered appropriate by an operator. Factors for consideration by the operator are based on the material being baled, condition of the bales and the predetermined or desired dimensions of the bales.

In the arrangement illustrated in FIG. 1, for example, the position or alignment of the interior elements 20, 22 is adjustable between a non-tapered position (represented by respective dashed lines 20', 22′ in FIG. 1) and a maximum tapered position, in which the position or alignment of the interior elements is identified by reference characters 20, 22. In FIG. 1, the bales “B₁”, “B₂”, and “B₃” are shown occupying the channel 28. The adjustment devices 24, 26 enable the operator to adjust the positions of the interior elements 20, 22 relative to the sidewalls 16, 18, to take the condition of the bales into account.

As the bales are moved through the tapered channel, the bales are increasingly squeezed laterally between the interior elements 20, 22. In these circumstances, the lateral pressure on the respective bales increases as each bale moves through the channel 28, until the bales exit the exit chamber housing 10.

Accordingly, as they move through the conventional exit chamber housing, the bales are each subjected to a relatively rapid increase in lateral pressure over a short time period when the interior elements are in the fully tapered position. Also, the pressure to which the bales are subjected is quickly released upon each bale exiting from the conventional exit chamber housing 10. As a consequence, the tendency of the crop material in the bales to spring back may be exacerbated by the conventional exit chamber housing.

For example, in FIG. 1, a portion “P” of the bale “B₁” is shown extending beyond the back end 14 of the exit chamber housing 10, as the bale “B₁” exits the conventional exit chamber housing 10. Arrows “D₁”, “D₂” generally indicate the outward directions in which the crop material in bale B₁ tends to spring back, once the crop material is no longer constrained between or by the interior elements 20, 22. It will be understood that the extent of the “spring-back” illustrated in FIG. 1 is exaggerated, for clarity of illustration.

Therefore, there is provided a novel adjustable bale forming chamber system that addresses at least some of the disadvantages of current solutions.

### SUMMARY

For the foregoing reasons, there is a need for an adjustable bale forming chamber system that overcomes or mitigates one or more of the defects or deficiencies of the prior art.

In its broad aspect, the disclosure is directed at an adjustable bale forming chamber housing system for compressing bales. The adjustable bale forming chamber housing includes a frame extending between a front end at which the bales are received and a back end at which the bales exit the adjustable bale forming chamber housing. The adjustable bale forming chamber housing includes an interior element subsystem that includes a pair of fore and a pair of aft interior elements that are movable between a wide condition and narrow condition thereof, the pair of fore elements being pivoted upon the bale forming chamber frame, and the pair of aft elements being pivoted at the rear of the pair of fore elements. The adjustable bale forming chamber housing also includes an actuation subsystem, for moving the interior elements between the narrow condition and the wide condition.

In some embodiments, the bale may experience the highest level of compression or pressure between a middle of the chamber housing and an end of the chamber housing.

In some embodiments, the disclosure is directed at an adjustable bale forming chamber that compresses crop material to manage a density of the crop material and to create the bale

In one aspect of the disclosure, there is provided an adjustable bale forming chamber housing system for compressing bales, the adjustable bale forming chamber housing including a frame extending between a front end at which the bales are received in the adjustable bale forming chamber housing and a back end at which the bales exit the adjustable bale forming chamber housing; an interior element subsystem including a pair of interior elements defining a channel, the pair of interior elements movable between a narrow position, in which a narrow channel is at least partially defined between the interior elements, and a wide position, in which a wide channel is at least partially defined between the interior elements; wherein each of the interior elements includes a first interior element portion and a second interior element portion; wherein the second interior element portion is hingedly connected to the frame and the first interior element portion is hingedly connected to the second interior element portion; and an actuation subsystem, for moving the interior elements between the narrow position and the wide position.

In another aspect, the actuation subsystem moves the pair of interior elements parallel or somewhat parallel to each other. In a further aspect, the actuation subsystem includes separate actuators for each of the pair of interior elements to move the interior elements and to maintain a spacing relationship between the pair of interior elements. In yet a further aspect, the actuation subsystem further includes separate actuators for each of the first interior element portions and second interior element portions of the pair of interior elements. In another aspect each of the first interior element portions is attached to a plate. In an aspect, the actuation devices are mounted to the adjustable bale forming chamber housing. In another aspect, the actuation system further includes a controller for controlling the actuation devices. In yet a further aspect, the set of actuation devices includes a set of upstream actuation devices; and a set of downstream actuation devices.

In another aspect, the actuation subsystem maintains a parallel relationship between the pair of interior elements. In yet another aspect, the system includes an apparatus for mounting the adjustable bale forming chamber housing system to a baler. In yet another aspect, the actuation devices are hydraulic cylinders, manual actuation devices or dynamic actuation devices. In another aspect, the system includes an intake assembly connected to the pair of interior elements for guiding the bales received at the front end towards the channel. In yet a further aspect, the intake assembly is integrated with the second interior element portions of the pair of interior elements.

In another aspect, the system further includes a linkage assembly for maintaining the parallel relationship between the pair of interior elements. In yet another aspect, the linkage assembly comprises a linkage subassembly connected to each of the pair of interior elements.

### BRIEF DESCRIPTION OF THE DRAWINGS

The disclosure will be better understood with reference to the attached drawings, in which:

FIG. 1 is a schematic illustration of a prior art exit chamber housing;

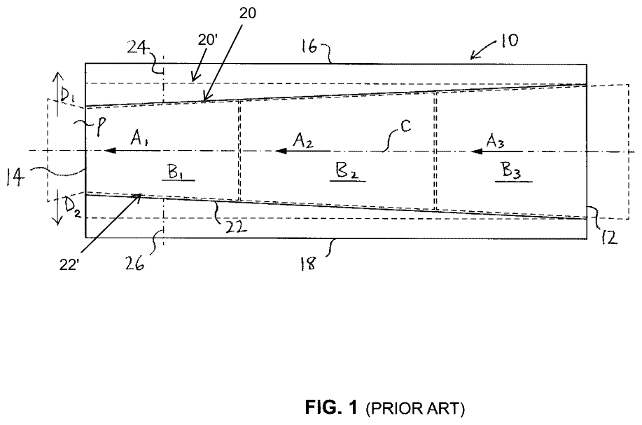

FIG. 2A is a schematic illustration of an embodiment of an adjustable bale forming chamber system of the disclosure including an actuation subsystem and the adjustable bale forming chamber housing;

FIG. 2B is a perspective view of a baler and an embodiment of an adjustable bale forming chamber system, drawn at a smaller scale;

FIG. 3A is a perspective view of the bale forming chamber housing of FIG. 2 showing a back end thereof, drawn at a larger scale;

FIG. 3B is a perspective view of the bale forming chamber housing of FIG. 2 showing a front end thereof;

FIG. 4 is a horizontal cross-section of the bale forming chamber housing of FIG. 3A in which interior elements of an interior element subsystem of the bale forming chamber housing are in first positions thereof, drawn at a larger scale;

FIG. 5 is a horizontal cross-section of the bale forming chamber housing of FIG. 3A in which the interior elements of the interior element subsystem are in second positions thereof;

FIG. 6 is an overlay view in which the interior elements in the first position are shown in solid lines, and in which the interior elements in the second position are shown in dashed lines;

FIG. 7A is a perspective view of a portion of a second side of the bale forming chamber housing of FIG. 5, drawn at a larger scale;

FIG. 7B is another perspective view of a portion of the second side of the bale forming chamber housing of FIG. 4;

FIG. 8A is a perspective view of a portion of the second side of the bale forming chamber housing of FIG. 4;

FIG. 8B is another perspective view of a portion of the second side of the bale forming chamber housing of FIG. 5;

FIG. 9 is a schematic illustration of another embodiment of the system of the invention including an actuation subsystem and the adjustable chamber exit housing;

FIG. 10 is a perspective view of the baler and an alternative embodiment of the bale forming chamber housing of the invention, drawn at a smaller scale;

FIG. 11 is a horizontal cross-section of the baler and the bale forming chamber housing of FIG. 10 with bales positioned therein;

FIG. 12A is a perspective view of the bale forming chamber housing of FIGS. 10 and 11 showing a back end thereof, drawn at a larger scale;

FIG. 12B is a perspective view of the bale forming chamber housing of FIGS. 10, 11, and 12A showing a front end thereof;

FIG. 13 is a horizontal cross-section of the bale forming chamber housing of FIGS. 10 and 11 in which interior elements of an interior element subsystem of the bale forming chamber housing are in first positions thereof, drawn at a larger scale;

FIG. 14 is a horizontal cross-section of the bale forming chamber housing of FIGS. 10 and 11 in which the interior elements are in second positions thereof;

FIG. 15 is an overlay view in which the interior elements in the first position are shown in solid lines, and in which the interior elements in the second position are shown in dashed lines; and

FIG. 16 is a horizontal cross-section of the bale forming chamber housing of FIGS. 10 and 11 in which the interior elements are positioned in non-parallel positions.

### DETAILED DESCRIPTION

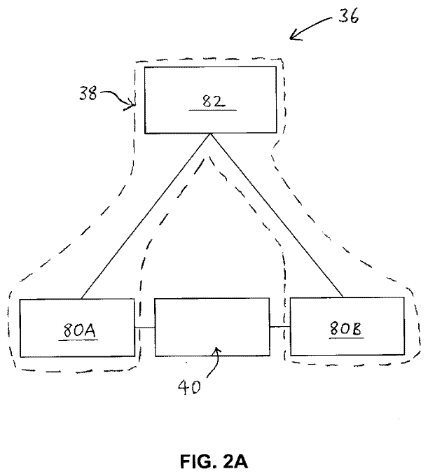

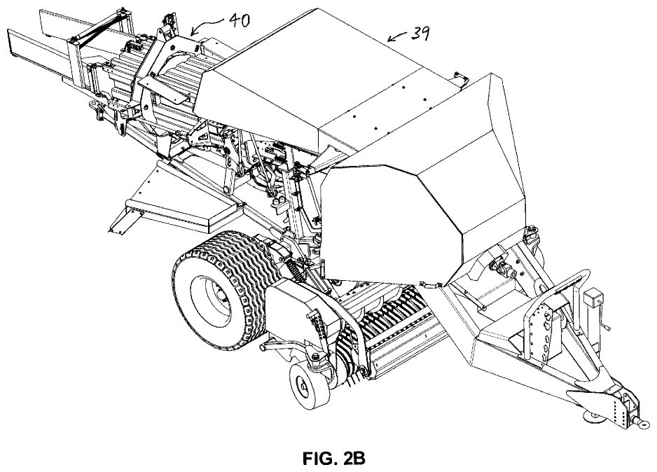

In the attached drawings, like reference numerals designate corresponding elements throughout. Reference is first made to FIGS. 2A-8B to describe an embodiment of an adjustable bale forming chamber system in accordance with the disclosure indicated generally by the numeral 36. In the current embodiment, the adjustable bale forming chamber system 36 includes an actuation subsystem 38 and an adjustable bale forming chamber housing 40 (FIG. 2A). The actuation subsystem 38 includes actuation devices 80A, 80B that are mounted to the adjustable bale forming chamber housing 40 and a controller 82 for controlling the actuation devices 80A, 80B, as will be described below. In some embodiments, the actuation devices 80A, 80B may be controlled or manipulated manually, dynamically or automatically whereby a controller 82, such as, but not limited to, a digital controller is not required.

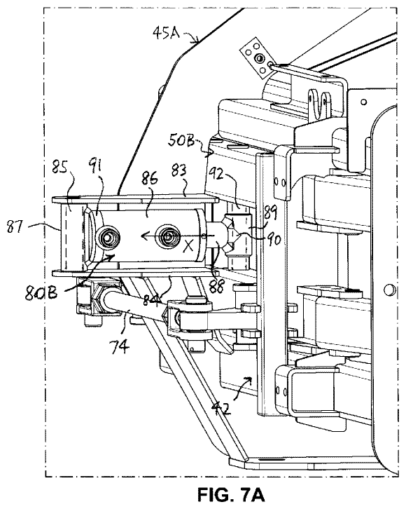

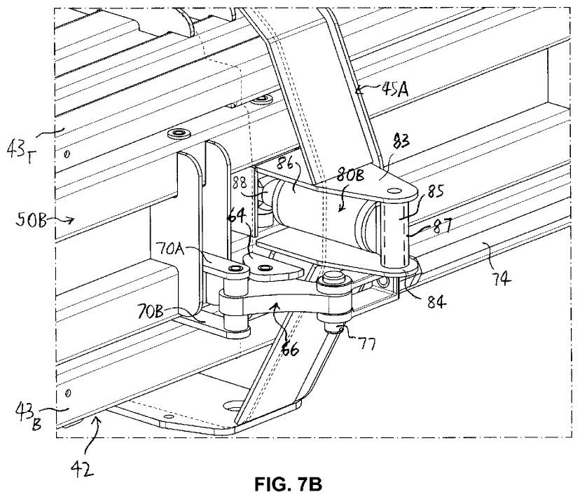

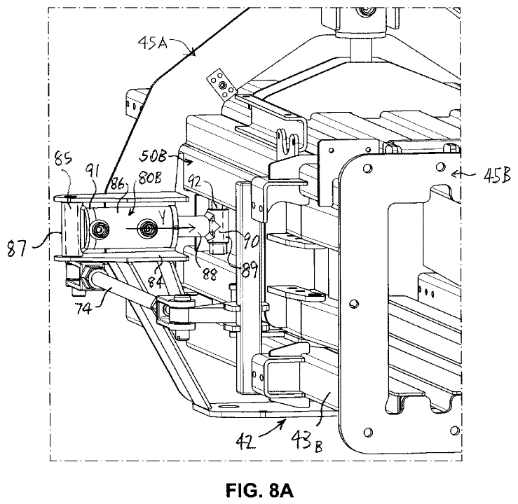

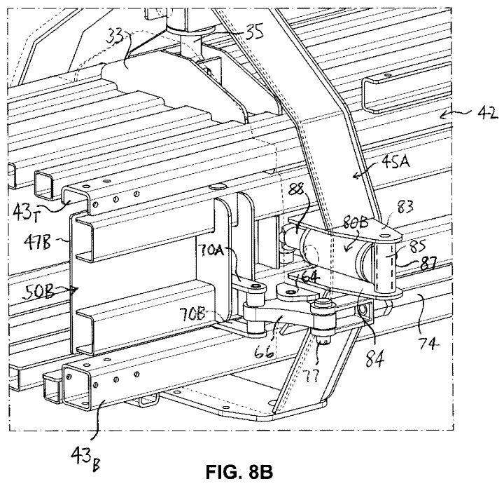

The actuation devices may be any suitable devices as will be understood by one skilled in the art. In one embodiment, the actuation devices 80A, 80B are hydraulic cylinders as shown in FIGS. 7A-8B.

As will be described, the adjustable bale forming chamber system 36 is for compressing newly-formed or partially formed bales, to limit or reduce “spring-back” (in the horizontal and/or vertical directions) after the bale exits the adjustable bale forming chamber system 36. In some embodiments, the bales may be tied before entering the adjustable bale forming chamber system 36. In some embodiments, the adjustable bale forming chamber is used to manage or control a density of the bale. In some embodiments, the adjustable bale forming chamber may only apply pressure or compression to the sides of the bale. In other embodiments, the adjustable bale forming chamber may only apply pressure or compression to a top and bottom of the bale. In yet other embodiments, the adjustable bale forming chamber may actively apply pressure or compression to any or all of, the sides, the top or the bottom of the bale.

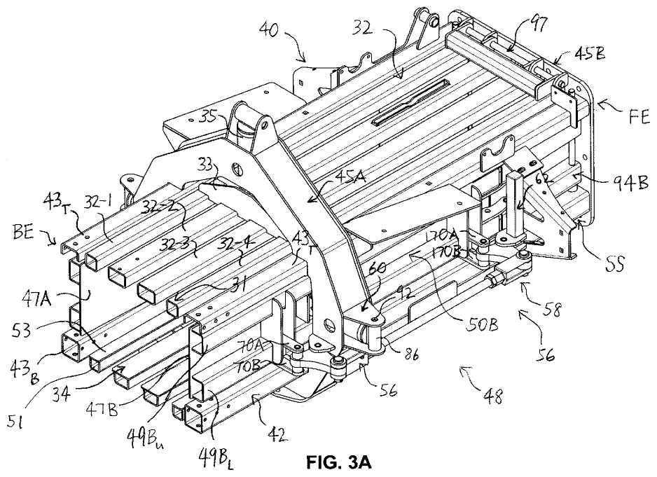

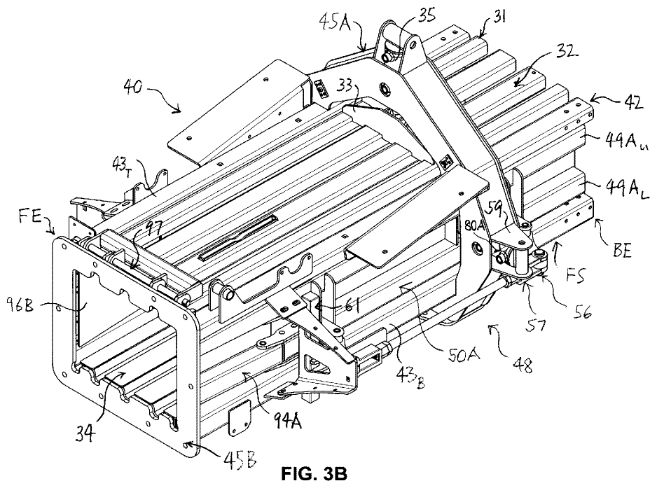

In FIG. 2B, the adjustable bale forming chamber housing 40 is shown mounted to a baler 39. In one embodiment, as shown in FIGS. 3A, 3B, the adjustable bale forming chamber housing 40 includes a frame 42 extending between a front end “FE” of the housing 40, at which the newly-formed bales are received and a back end “BE” of the housing 40, at which the bales exit the adjustable bale forming chamber housing 40. In this description, the terms “front” and “back” are used to differentiate between the different ends of the chamber housing 40 with “front” representing the end which receives the newly-formed bales and “back” representing the end through which the compressed bales exit. The following description also uses the terms “upstream” and “downstream” which relate to the direction of travel of the bales within the chamber system 36. As can be seen in FIGS. 3A and 3B, the frame 42 has first and second sides “FS”, “SS”.

In FIGS. 3A and 3B, the frame 42 includes a set of top side members 43_{T} and a set of bottom side members 43_{B}. In the current embodiment, two top and two bottom side members 43_{T}, 43_{B} are secured to transverse elements 45A, 45B of the frame 42. One of the two top side members 43_{T} is positioned on the first (FS) and the other of the two top side members 43_{T} is positioned on the second (SS) sides of the frame 42. The two bottom side members 43_{B} are similarly positioned.

As can be seen in FIGS. 3A and 3B, the frame 42 includes a bottom wall 34. The bottom wall 34 extends between the front end “FE” and the back end “BE” of the housing 40. As shown, the transverse elements 45A, 45B are secured to the bottom wall 34 and the top and bottom side members 43_{T}, 43_{B}.

The housing 40 includes a top section, portion or wall 32 that is pivotably connected to the front transverse element 45B, so that a downstream end 31 or the end of the top wall 32 near the “BE” is movable relative to the top side members 43_{T}. As indicated above, in the following, the terms “upstream” and “downstream” define or refer to the direction in which the bales are travelling within the adjustable bale forming chamber housing 40.

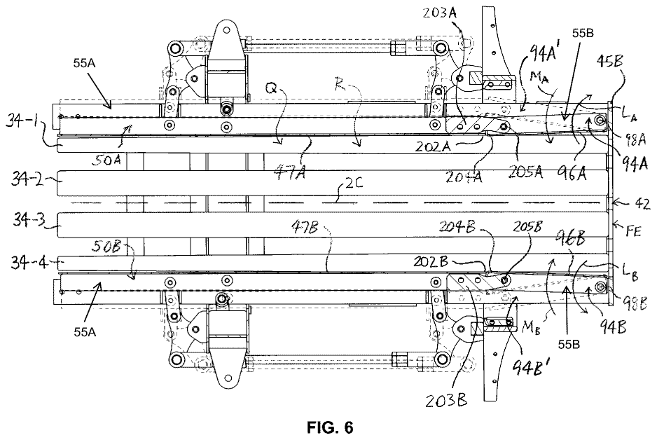

As shown in FIG. 3A, the top wall 32 includes a set of tubes, channels, extruded shapes and the like, that are individually identified by reference characters 32-1 to 32-4 and the bottom wall 32 is formed of a number of parallel floor elements. The floor elements that form the bottom wall 34 are individually identified by reference characters 34-1 to 34-4 inclusive in FIG. 6. Each floor element of the bottom wall 34 includes a supporting tube 51 and/or a floor plate 53 positioned on the supporting tube 51 (FIG. 3A). The supporting tube 51 may also be channels, extruded shapes and the like.

In other embodiments, those skilled in the art would appreciate that the top wall 32 and the bottom wall 34 may be formed of any other suitable components.

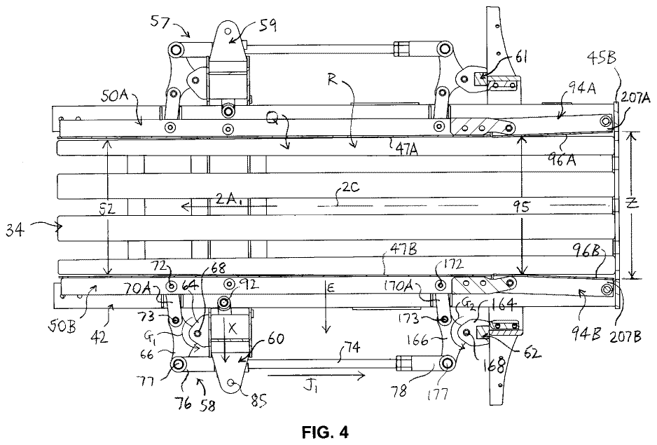

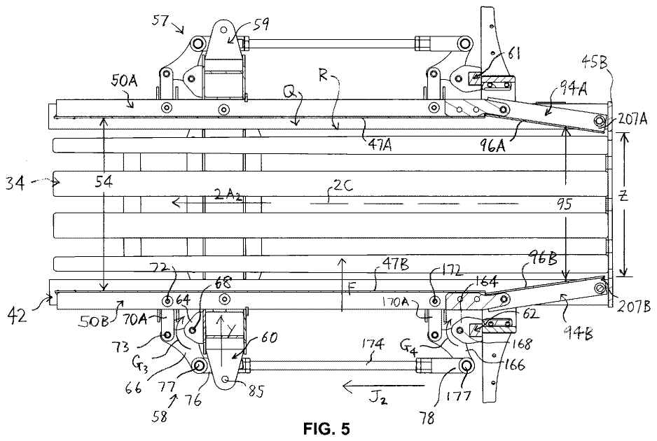

The adjustable bale forming chamber housing 40 includes an interior element subsystem 48 (FIGS. 3A, 3B). The interior element subsystem 48 includes one or more interior elements 50 that are movable, relative to the frame 42, between a narrow condition or position (FIG. 4) and a wide condition or position thereof (FIG. 5). The interior elements 50 may also be located in any intermediate condition or position between the narrow and wide conditions or positions. In the embodiment illustrated in FIGS. 2A-8B, the interior element subsystem 48 includes first and second interior elements identified by reference characters 50A, 50B respectively. In the current embodiment, each of the interior elements 50A, 50B include a first interior element portion 55A and a second interior element portion 55B (FIG. 6).

As can be seen in FIGS. 3A and 3B, the interior elements 50A, 50B are positioned between the top side members 43_{T} and the bottom side members 43_{B} of the frame 42, on each side of the housing 40. The interior elements 50A, 50B are movable relative to the top and bottom side members 43_{T}, 43_{B} on each side of the housing 40, as will be described below. While not necessary in each embodiment, in the current embodiment, the interior elements 50A, 50B are parallel to each other.

As can also be seen in the embodiment of FIG. 4, the first interior element portion supports substantially flat plates 47A, 47B mounted on inner sides of the first interior element portions 51A, for defining a main channel “Q” of the housing 40 (FIGS. 4-6) and engaging the sides of the bales, as the bales move through the main channel “Q” of the adjustable bale forming chamber housing 40. The plates 47A, 47B are sufficiently smooth to allow the bales to be squeezed (laterally compressed) therebetween while moving through the main channel “Q”. In one embodiment, as can be seen in FIGS. 3A and 3B, the interior elements 50A, 50B also include respective upper and lower ribs 49Aᵤ, 49Bᵤ, 49A_{L}, and 49B_{L}, to support the plates 47A, 47B. In other embodiments, where the flat plates corresponding to the interior elements are positioned parallel to the top or bottom wall, the flat plates may compress or apply pressure to the bale in a vertical direction. Whether applying the pressure laterally or vertically, the plates may also apply pressure to the bale to adjust, manage or control a density of the forage or crop material in the bale.

When the interior element subsystem 48 is in its narrow position, the interior elements 50A, 50B are positioned to locate the plates 47A, 47B to define the main channel “Q” at its narrowest width, so that the plates 47A, 47B are separated by a first distance 52 (FIG. 4). When the interior element subsystem 48 is in its wide position, the interior elements 50A, 50B are positioned to locate the plates 47A, 47B to define the main channel “Q” at its widest width, so that the plates 47A, 47B are separated by a second distance 54 (FIG. 5). As can be seen in FIGS. 4 and 5, the plates 47A, 47B attached to the interior elements 50A, 50B are parallel to each other to define the main channel “Q”. The interior elements 50A, 50B may also be parallel to each other. The plates 47A, 47B may also be positioned to locate the plates 47A, 47B to define the main channel “Q” at a width between the narrowest and widest widths.

When the baler is producing bales, the bales are moved in the directions indicated by arrows “2A₁” and “2A₂” in FIGS. 4 and 5 through the channel “Q” defined by the plates 47A, 47B based on the positioning of the first and second interior elements 50A, 50B.

When the interior element subsystem 48 is in its narrow position, the interior elements 50A, 50B are in their respective first positions (FIG. 4). Similarly, when the interior element system 48 is in its wide position, the interior elements 50A, 50B are in their respective second positions (FIG. 5). The interior elements 50A, 50B may also be positioned in any intermediate positions, between their respective first and second positions. As will be described, regardless of the position of the interior elements 50A, 50B, in the current embodiment, the plates 47A, 47B attached to the interior elements 50 are located or positioned parallel to each other.

From the foregoing, it can be seen that the interior elements 50A, 50B may be positioned to define any selected intermediate channel width that is between the narrowest width 52 and the widest width 54, and that the plates 47A, 47B connected to the interior elements 50A, 50B are parallel to each other when they are in any such intermediate position, and also when moving between positions.

In summary, in the described embodiment, the interior elements 50A, 50B are positioned between the top and bottom side members 43_{T}, 43_{B}, and the interior elements 50A, 50B are laterally movable, while parallel to each other, relative to the top and bottom side members 43_{T}, 43_{B}. The interior elements 50A, 50B are held parallel to a center line “2C” of the housing 40 while they move relative to the frame 42 (FIGS. 4-6). The bottom wall 34 supports the bales moving through the housing 40. Alternatively, the chamber housing may include interior elements and/or plates that are vertically movable to apply compression or pressure to a top and/or bottom of the bale.

As noted above, in one embodiment, the interior elements 50A, 50B are parallel, or substantially parallel, when the interior element subsystem 48 is in the narrow and wide positions, and in any intermediate position therebetween. In specific embodiments, the interior elements 50A, 50B are positionable to define a channel that has a width varying between a minimum, or narrow, width of, for example, about 16 ⅜ inches and a maximum, or wide, width of, for example, about 20 ⅝ inches.

The ability to adjust a width of the main channel “Q” between narrow and wide widths is believed to be advantageous, because it enables an operator to adjust the channel width at any time, based on the prevailing conditions. The conditions include, but are not limited to, the type of crop material being collected, how leafy the crop material is and/or weather conditions. Examples of crop material include, but are not limited to, straw, hay, grass, and/or legumes.

For example, where the bale width is intended to be controlled i.e. 18 inches, but the side of the bale springs back to provide a width of about 19 inches, the operator may position the interior elements 50A, 50B to define a channel width of about 17 inches, i.e., to compress the sides of the bale by approximately 0.5 inch on each side, resulting in a bale width of about 18 inches. In some embodiments, the interior elements 50A, 50B may be used to control a height or a density rather than a width of the bale. While the current description describes the interior elements for controlling a width of the bale, it is understood that a similar mechanism or apparatus can be used or implemented to control or adjust a height of the bale or density of the bale.

As will be understood, there may be expectations with respect to the characteristics of finished bales (bales exiting the adjustable bale forming chamber system 36) with respect to width after spring-back. In some embodiments, upon initiation of the baling process, the operator may stop the baler after completing a predetermined number of bales to measure the spring-back being experienced by the completed bales. The operator can then adjust the interior elements to address the spring back experienced by these completed bales such that future completed bales match expected or desired width characteristics. The operator may perform this check more than once until the completed bales meet with the expected width characteristics. The operator can then continue baling with the understanding that the completed bales meet the expected width characteristics. If the conditions, such as those listed above, change, the operator may need to perform checks on the bales that are completed under the new conditions to determine if the interior elements have to be re-adjusted so that the bales completed under the new conditions meet the extended width characteristics. An advantage of the current disclosure is that due to the length of the plates 47A, 47B, the bales may be compressed (laterally and/or vertically) for an extended period of time to reduce the amount of spring back experienced by the bales. Furthermore, the disclosure provides more adjustability to channel width due to the design of the interior element subsystem. Although the compression is described as being lateral, it is understood that the compression may also be applied vertically to adjust for spring-back or to adjust a density of the bale.

When the interior elements 50A, 50B are positioned as required or desired (i.e., according to the conditions), the bales moving through the channel therebetween are squeezed or compressed between the plates 47A, 47B as positioned by the interior elements 50A, 50B along their entire respective lengths. As noted above, the plates 47A, 47B are smooth, to facilitate movement of the bales through the channel while the bales are laterally compressed (i.e., compressed at the sides thereof). The lateral compression to which the bales are subjected is substantially constant, while the bales are in the channel or adjustable bale forming chamber housing 40. Because the lateral compression is limited in its extent, and because the bales are subjected to the lateral compression between the plates 47A, 47B for an extended period of time before they are released from the housing 40, the bales tend to remain at least partially laterally compressed after exiting the housing 40. Accordingly, the system of the disclosure minimizes or reduces “spring-back”. As previously discussed, depending on a design of the interior elements, the interior elements may also be used to reduce spring-back that may occur in a vertical direction such that the interior elements compress the top and bottom of the bales. Alternatively, the interior elements may also apply compression or pressure to the bales to adjust a density of the bales. When applying compression with respect to the density, the system of the disclosure may assist to manage a more consistent or high level of density within the bale.

As can be seen in FIGS. 4-6, in one embodiment, the adjustable bale forming chamber housing 40 also includes first side and second side intake assemblies 94A, 94B that are generally positioned at the front end “FE” of the frame 42 and between the respective interior elements 50A, 50B. In some embodiments, the intake assemblies 94A, 94B are the second interior element portions 55B and in some embodiments, the intake assemblies are integrated or mounted to the second interior element portions 55B. The intake assemblies 94A, 94B include panels 96A, 96B (FIGS. 4, 5). As will be described, the intake assemblies 94A, 94B are formed for guiding the bales entering the adjustable bale forming chamber housing 40 to slidingly engage the plates 47A, 47B of the interior elements 50A, 50B (FIG. 6). In other words, the intake panels 96A, 96B define an intake channel 95 therebetween, for guiding the bales into the channel “Q” towards and between the plates 47A, 47B.

As shown in at least FIG. 6, the second interior element portion 55B is hingedly connected to the frame 42 and the first interior element portion 55A. This will be described in more detail below. The hinged connection between interior elements with the frame and the hinged connection between the interior element portions assist to maintain a spaced relationship between the interior elements as they move between the narrow and wide positions.

As will be described, the first and second side intake assemblies 94A, 94B are pivotably connected with the first and second side interior elements 50A, 50B respectively such that the intake assemblies 94A, 94B are pivotably moved when the interior elements 50A, 50B are moved.

In some embodiments, the intake channel 95 and the main channel “Q” collectively form a bale forming chamber housing channel “R” that extends between the front end “FE” and the back end “BE” of the housing 40 (FIGS. 4-6). As noted above, the width of the main channel “Q” may be adjusted by the operator (via movement of the interior elements 50A, 50B) to adjust to changes in conditions into account, and the width of the intake channel at its downstream end or end proximate the beginning of the main channel “Q” varies with changes in the width of the main channel “Q”. The width of the main channel “Q” may be optimized (i.e., adjusted) as required, and the intake channel is formed to guide or direct the bales into the upstream end of the main channel “Q” (the end of the main channel “Q” proximate the downstream end of the intake channel), even though the width of the main channel “Q” varies.

The actuation subsystem 38 is configured for locating the interior elements 50A, 50B in the first positions thereof illustrated in FIG. 4 (to define the narrow condition thereof) and the second positions thereof illustrated in FIG. 5 (to define the wide condition thereof), and in any intermediate positions therebetween.

In the current embodiment, the housing 40 further includes first and second side linkage subassemblies 57, 58, located at the first and second sides “FS”, “SS” respectively (FIGS. 3A, 3B). In some embodiments, an adjustment assembly 56 that includes the first and second side linkage subassemblies 57, 58 is configured to keep the interior elements 50A, 50B parallel as they are moved between the first and second positions thereof by the actuation devices 80A, 80B.

As noted above, the actuation subsystem 38 includes the first and second actuation devices 80A, 80B, which are configured for moving the interior element subsystem 48 between the narrow and wide positions thereof. The first and second actuation devices 80A, 80B are connected to the first and second interior elements 50A, 50B respectively, and also to the frame 42, at each side “FS”, “SS” thereof. In some embodiments, the first and second actuation devices 80A, 80B are identical in all relevant respects. To simplify the description, only the second actuation device 80B and the second linkage subassembly 58 are described in detail hereinafter, however, it is understood that the first actuation device 80A and the first linkage subassembly 57 operate in a similar or identical manner. It will be understood that, in some embodiments, the first and second side linkage subassemblies 57, 58 are the same in all relevant details, except that they are mirror images of each other.

As will be described, via the controller 82 (or in some embodiments, manually), the hydraulic cylinders 80A, 80B are activated and de-activated simultaneously with the same or different pressures, to result in simultaneous (or substantially simultaneous) corresponding parallel movements of the interior elements 50A, 50B.

Those skilled in the art would appreciate that the controller 82 may be any device that is suitable for controlling the actuation devices 80A, 80B and may be located in any suitable location. For instance, the controller may be located in the cab of a tractor (not shown) that tows the baler 39 so that it is easily accessible by the operator. Also, it will be understood that the controller 82 may be configured in any suitable way, e.g. for automatic operation of the system, and/or manual operation thereof.

In one current embodiment, the first and second side linkage subassemblies 57, 58 indirectly connect the interior elements 50A, 50B to the frame 42 to keep the interior elements 50A, 50B parallel. Each of the linkage subassemblies is connected to an interior element at upstream (near or towards the front end “FE”) and downstream (near or towards the back end “BE”) locations on the interior element 50.

In another embodiment, the first and second side linkage subassemblies 57, 58 have differing lengths but may still indirectly connect the interior elements 50A, 50B to the frame 42 so the interior elements 50A, 50B are not parallel but maintain a positional relationship. In some embodiments, each of the linkage subassemblies is connected to an interior element at upstream (near or towards the front end “FE”) and downstream (near or towards the back end “BE”) locations on the interior element 50.

As can be seen in FIGS. 3A and 3B, the transverse element 45A includes first and second platforms 59, 60 that are mounted at the first and second sides “FS”, “SS” of the frame 42 respectively and are located downstream (relative to the direction of travel of the bales through the channel) from corresponding first and second mounts 61, 62 thereof (FIGS. 3A, 3B). In the current embodiment, the first and second mounts 61, 62 are secured to the top and bottom side members 43_{T}, 43_{B} (FIGS. 3A, 7A).

As can be seen in FIG. 4, the second side subassembly 58 includes a nose element 64 that is secured to transverse element 45A. A connector 66 is pivotably connected to the nose 64 by a pin 68. Links 70A, 70B are pivotably connected to the second interior element 50B by a pin 72. The links 70A, 70B are pivotably connected with the connector 66 by a pin 73. As can be seen in FIG. 4, the links 70A, 70B are parallel to each other and spaced apart vertically. The ribs 49Bᵤ, 49B_{L} are secured together by brackets at a downstream location proximal to the pin 72.

As can be seen in FIG. 4, the connector 66 is also pivotably connected with an arm 74 at a downstream end 76 of the arm 74, by a pin 77.

The arm 74 is pivotably connected, at an upstream end 78 thereof, with an upstream connector 166 by a pin 177. As can be seen in FIG. 4, the upstream connector 166 is pivotably connected with a nose 164 that is secured to the second mount 62.

As shown, links 170A, 170B are pivotably connected with the connector 166 by a pin 173 (FIG. 4) at one end and pivotably connected with the interior element 50B by a pin 172 at an opposite end.

As can be seen in FIG. 4, the second side subassembly 58 is pivotably connected with the interior element 50B by the two connecting pins 72, 172, which are spaced apart and are equidistant from the center line “2C”.

As shown in FIGS. 7A-8B, the second actuation device 80B, which may be a hydraulic cylinder, is connected to the interior element 50B and to the second side “SS” of the frame 42 (i.e., to the transverse element 45A). The second platform 60 includes upper and lower plates 83, 84 inside which the second actuation device, or hydraulic cylinder, 80B is mounted (FIGS. 4, 5). A pin 85 extends between the plates 83, 84. The pin 85 is shown in dashed outline in FIGS. 7A-8B.

The second actuation device 80B includes a hydraulic cylinder body 86 (FIGS. 7A, 8A). Although not shown, a piston is located within the hydraulic cylinder body 86 and a rod 88 that is connected to the piston extends from the body 86. The second actuation device 80B is pivotably connected, at an inner end 90 of the rod 88, to a pin 92 that is secured to the interior element 50B. The pin 92 is shown in dashed outline in FIG. 7A. As can be seen in FIG. 7A, the second hydraulic cylinder 80B includes a bushing 89 mounted at the end 90 of the rod 88 that fits around the pin 92. Accordingly, the hydraulic cylinder is, via its pivotable connection to the pin 92, connected to the interior element 50B.

At an outer end 91 of the second hydraulic cylinder 80B, the second hydraulic cylinder 80B includes a bushing 87 that is mounted to the pin 85. It can be seen in FIG. 7A that the second hydraulic cylinder 80B is pivotably connected via the bushing 87 at its outer end 91 to the pin 85. The plates 83, 84 are secured to the transverse element 45A, and the pin 85 is held between the plates 83, 84. Accordingly, the second hydraulic cylinder 80B is, via its pivotable connection to the pin 85, connected to the frame 42.

It will be understood that a number of elements or components that are not necessary for explaining the functionality and/or structure of the disclosure are omitted from FIGS. 7A-8B for clarity of illustration.

From the foregoing, it can be seen that the second side subassembly 58 is also connected with the interior element 50B at the pin 72.

As can be seen in FIGS. 7A and 8A, at its outer end 91, the body 86 of the second hydraulic cylinder 80B is pivotably connected to the frame 42 via connection to the pin 85, which is connected to the transverse element 45A, however, the inner end 90 of the rod 88 of the second hydraulic cylinder 80B is pivotably connected to the interior element 50B. As a result, movement of the rod 88 relative to the hydraulic cylinder body 86 causes corresponding movement of the interior element 50B relative to the frame 42.

In one embodiment, the second hydraulic cylinder 80B may be activated by the controller 82, to cause the rod 88 to be moved between an extended condition (FIGS. 7A, 7B) and a retracted condition (FIGS. 8A, 8B), while the other first hydraulic cylinder 80A is also correspondingly activated by the controller 82 at the same time. In some embodiments, the actuation devices, which in the current embodiment are hydraulic cylinders, 80A, 80B are controlled to have corresponding movements of their respective rods (i.e., in opposite directions) at the same time, or at substantially the same time. That is, the rods of the respective hydraulic cylinders 80A, 80B are both moved outwardly at the same rate, and to the same extent, at the same time. Also, the rods of the respective hydraulic cylinders 80A, 80B are both moved inwardly at the same rate, although different rates may be contemplated, and to the same extent, at the same time. The result is that the interior elements 50A, 50B are located equidistant from the center line “2C”, regardless of whether the interior elements 50A, 50B are in their respective first or narrow positions, second or wide positions, or any intermediate positions therebetween. The position of the hydraulic cylinders may also be determined based on the hydraulic pressure in the hydraulic cylinder such that the hydraulic cylinder maintains a consistent or contact pressure on the bale during crop variations.

Those skilled in the art would appreciate that, alternatively, the interior elements 50A, 50B may be moved at different times, e.g., a few minutes apart, if necessary. It will also be understood that, in an alternative embodiment, the system 36 may be operated without the controller 82. In this alternative embodiment, the actuation devices 80A, 80B may be operated independently, for corresponding movement of the rods thereof, at different times.

As can be seen in FIGS. 4, 7A, and 7B, movement of the rod 88 from the extended condition thereof to the retracted condition thereof is in the direction indicated by arrow “X”. Similarly, in FIGS. 5, 8A, and 8B, movement of the rod 88 from the retracted condition to the extended condition is in the direction indicated by arrow “Y”.

As can be seen in FIGS. 4, 7A and 7B, when the second hydraulic cylinder 80B is in its extended condition, the interior element 50B is in its first or narrow position. In response to the second hydraulic cylinder 80B moving from its extended condition to its retracted condition, the rod 88 moves in the direction indicated by arrow “X”, causing the interior element 50B to move in the direction indicated by arrow “E”, toward its second or wide position.

As can be seen in FIGS. 5, 8A, and 8B, when the second hydraulic cylinder 80B is in its retracted condition, the interior element 50B is in its second position. Upon the second hydraulic cylinder 80B moving from its retracted condition to its extended condition, the rod 88 moves in the direction indicated by arrow “Y”, causing the interior element 50B to move in the direction indicated by arrow “F”, toward its first position.

Those skilled in the art would appreciate that the second hydraulic cylinder 80B may locate the rod 88 at an intermediate location or position, so that the interior element 50B is then positioned at a selected intermediate position, between the first and second positions thereof.

As can be seen in FIG. 4, movement of the rod 88 in the direction indicated by arrow “X” causes the links 70A, 70B to move in the outward direction generally indicated by arrow “E”, causing the downstream connector 66 to pivot about the pin 68 in a counter-clockwise direction (as illustrated in FIG. 4), indicated by arrow “G₁”. Such pivoting movement causes the arm 74 to be correspondingly moved in the direction indicated by arrow “J₁” in FIG. 4.

As can also be seen in FIG. 4, such movement of the arm 74 causes the upstream connector 166 to pivot about the pin 168 in a counter-clockwise direction, indicated by arrow “G₂”. Such pivoting movement causes the links 170A, 170B to be pulled in the outward direction generally indicated by arrow “E”.

From the foregoing, it can be seen that, to move the interior element 50B from its first position (FIG. 4) to its second position (FIG. 5), the second hydraulic cylinder 80B retracts the rod 88 in the direction indicated by arrow “X”. At the same time (or at substantially the same time), the links 70A, 70B are pushed outwardly in the direction generally indicated by arrow “E”, causing corresponding movement of the arm 74, and corresponding movement of the links 170A, 170B, also in the outward direction generally indicated by arrow “E”. In this way, the interior element 50B is maintained in a position parallel to the interior element 50A as the interior element 50B is moved from its first position to its second position.

At the same time, or at substantially the same time, the interior element 50A is moved outwardly, in a direction as indicated by arrow “E”.

As noted above, movement of the rod 88 from the retracted condition toward the extended condition causes movement of the interior element 50B in the inward direction generally indicated by arrow “F”. Such movement causes the links 70A, 70B to be pulled in the same direction, causing the downstream connectors 66 to pivot about the pin 68 in a clockwise direction, indicated by arrow “G₃” (FIG. 5). Such pivoting movement pulls the arm 74 in the direction indicated by arrow “J₂” in FIG. 5.

As can be seen in FIG. 5, the movement of the arm 74 in the direction indicated by arrow “J₂” causes the upstream connector 166 to pivot about the pin 168 in a clockwise direction, indicated by arrow “G₄” (FIG. 5). Such pivoting movement in turn pushes the links 170A, 170B inwardly, in the direction generally indicated by arrow “F”.

From the foregoing, it can be seen that, to move the interior element 50B from its second position (FIG. 5) to its first position (FIG. 4), the second hydraulic cylinder 80B extends the rod 88 in the direction indicated by arrow “Y” (FIGS. 5, 8A). At the same time (or at substantially the same time), the links 70A, 70B are pulled inwardly, in the direction generally indicated by arrow “F”, causing corresponding movement of the arm 74, and corresponding movement of the links 170A, 170B, also in the direction indicated by arrow “F”. In this way, the interior element 50B is maintained in a position parallel to the interior element 50A as the interior element 50B is moved from its second position to its first position.

It will be understood that, at the same time (or at substantially the same time), the interior element 50A is moved inwardly, in a direction indicated by arrow “F”.

As noted above, in one embodiment, the hydraulic cylinders 80A, 80B are activated by the controller 82 to have corresponding movements of the rods thereof at the same time, or at substantially the same time. Accordingly, in this embodiment, both of the interior elements 50A, 50B are maintained in positions parallel to each other as they are moved between their respective first and second positions.

Because the parallel interior elements 50A, 50B define a channel (between the plates 47A, 47B connected to the interior elements 50A, 50B) extending substantially along the lengths thereof, the bales passing through the main channel “Q” are subjected to substantially the same laterally directed pressure over an extended period of time, decreasing the tendency of the bales to “spring back” after exiting the housing 40. It is therefore believed that the housing 40, when the interior elements 50A, 50B are positioned for laterally compressing the bales to an appropriate extent, produces bales that are less prone to “spring back” than the bales exiting conventional exit chambers.

In FIG. 6, the interior elements 50A, 50B that are in their respective first positions, and the intake assemblies that are positioned accordingly, are shown in solid outlines. The interior elements 50A, 50B that are in their respective second positions are shown in dashed outlines in FIG. 6, for clarity of illustration. The intake assemblies that are shown connected with the interior assemblies in their second positions are also shown in dashed outlines and are identified in FIG. 6 by reference characters 94A′, 94B′.

As can be seen in FIGS. 4-6, upstream ends 207A, 207B of the intake assemblies 94A, 94B are pivotably connected with the frame 42 at the front end “FE” by respective pins 98A, 98B. The intake assemblies 94A, 94B are also pivotably connected with the interior elements 50A, 50B at upstream ends 202A, 202B thereof by respective brackets 203A, 203B (FIG. 6). The brackets 203A, 203B are secured to the interior elements 50A, 50B at the respective upstream ends 202A, 202B. The brackets 203A, 203B extend over the intake assemblies 94A, 94B, and the intake assemblies 94A, 94B are pivotably connected, at downstream ends 204A, 204B thereof, with the brackets 203A, 203B by respective pins 205A, 205B (FIG. 6).

At the front end “FE”, the upstream ends 207A, 207B of the intake assemblies 94A, 94B define a relatively wide intake opening “Z” to the intake channel 95 (FIGS. 4-6).

Due to the pivotable connections of the respective downstream ends 204A, 204B of the intake assemblies 94A, 94B with the respective upstream ends 202A, 202B of the interior elements 50A, 50B, the downstream ends 204A, 204B move laterally with the respective interior elements 50A, 50B to which the downstream ends 204A, 204B are respectively connected. However, because the upstream ends 207A, 207B are pivotably connected to the frame 42 at the front end “FE”, the intake assemblies 94A, 94B pivot about the pins 98A, 98B when the downstream ends 204A, 204B move with the respective interior elements 50A, 50B.

For example, when the interior elements 50A, 50B are moved outwardly (i.e., from their respective first positions toward the second positions thereof), the downstream ends 204A, 204B of the intake assemblies 94A, 94B pivot about the pins 98A, 98B as indicated by arrows “L_{A}”, “L_{B}” (FIG. 6), because the downstream ends 204A, 204B are pulled outwardly when the interior elements 50A, 50B move toward the second positions thereof. Similarly, when the interior elements 50A, 50B are moved inwardly (i.e., from their respective second positions toward the first positions thereof), the downstream ends 204A, 204B of the intake assemblies 94A, 94B pivot about the pins 98A, 98B as indicated by arrows “M_{A}”, “M_{B}” (FIG. 6), because the downstream ends 204A, 204B are pushed inwardly when the interior elements 50A, 50B move toward the first positions thereof. Accordingly, the downstream ends 204A, 204B of the intake assemblies 94A, 94B move with the interior elements 50A, 50B, when the interior elements 50A, 50B are moved between their respective first and second positions.

From the foregoing, it can be seen that the width of the intake channel 95 varies from its upstream end to its downstream end, i.e., between its width between the upstream ends 207A, 207B, and its width between the downstream ends 204A, 204B. At the upstream end of the intake channel 95, i.e., between the upstream ends 207A, 207B, of the intake assemblies 94A, 94B the intake channel 95 is at its widest, i.e., the width thereof at that point is the distance “Z” (FIGS. 4-6). In addition, because the positions of the downstream ends 204A, 204B of the intake assemblies 94A, 94B relative to the frame 42 change with movement of the interior elements 50A, 50B, the intake channel's width 95 is subject to change, except at its upstream end, i.e., between the upstream ends 207A, 207B of the intake assemblies 94A, 94B.

From the foregoing, it can be seen that because the downstream ends 204A, 204B are proximal to the plates 47A, 47B at the upstream ends 202A, 202B of the interior elements 50A, 50B, the bales are smoothly guided by the panels 96A, 96B to engage the plates 47A, 47B shortly after the bales enter the bale forming chamber housing 40.

As can be seen in FIG. 3A, in one embodiment, the top wall 32 is pivotably connected to the frame 42 by a hinge assembly 97 connected to the front transverse element 45B. At a downstream location, a bracket 33 secures the members 32-1, 32-2, 32-3, and 32-4 of the top wall 32 together. In the current embodiment, an actuation device 35 connects the bracket 33 and the transverse element 45A.

From the foregoing, it can be seen that the actuation device 35 may be controlled via a controller (such as controller 82, another controller or manually), e.g., by the operator, to raise or lower the downstream end 31 of the top wall 32 relative to the top side members 43_{T}, as required in view of the conditions. Those skilled in the art would appreciate that the operator may position the downstream end 31 of the top wall 32 to take the then current conditions into account, for instance, to press downwardly onto a top side of the bale, and to the extent required.

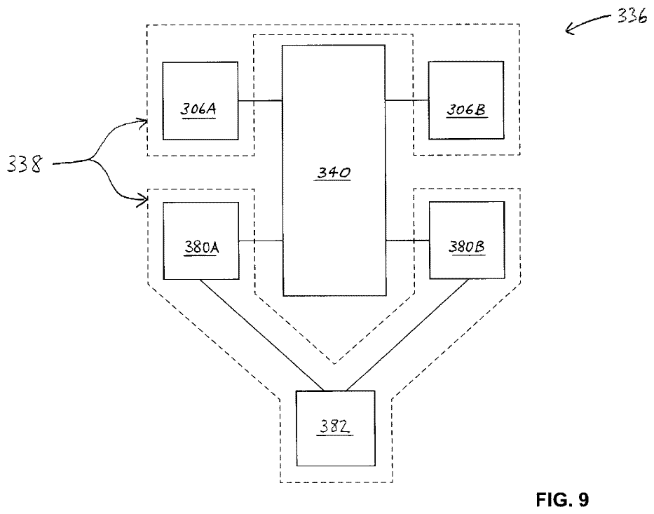

Another embodiment of an adjustable bale forming chamber system 336 of the disclosure is illustrated in FIGS. 9-16. The system 336 includes an actuation system 338 and an adjustable bale forming chamber housing 340 (FIG. 9-16).

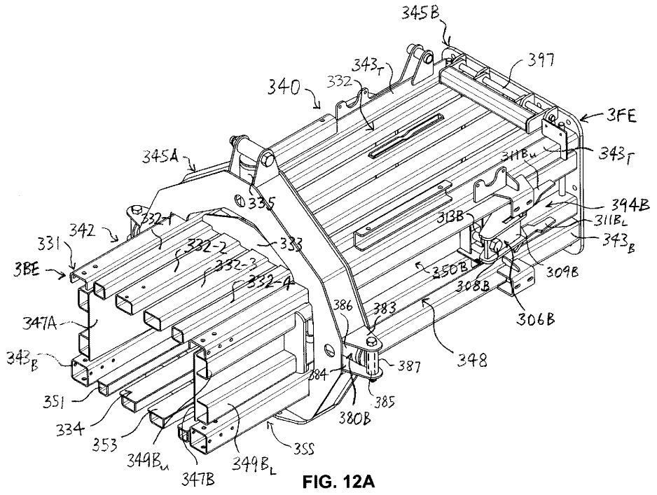

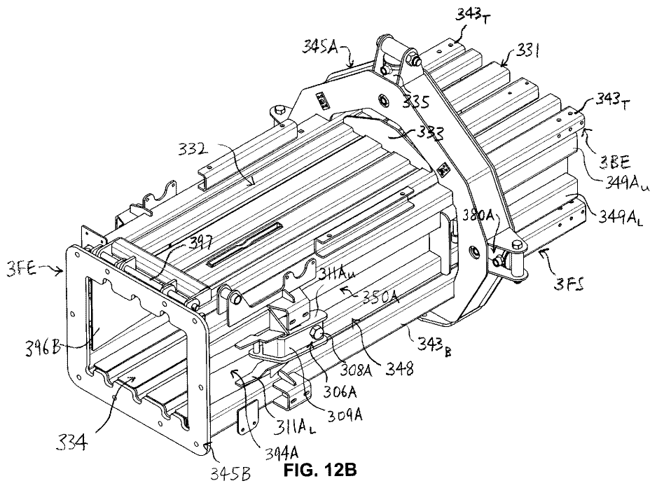

The actuation subsystem 338 includes downstream actuation devices 380A, 380B that are mounted to the adjustable bale forming chamber housing 340 (FIGS. 9, 12A-14) and upstream actuation devices 306A, 306B (FIGS. 9, 12A, 12B) that are also mounted to the adjustable bale forming chamber housing 340. In operation, the upstream actuation devices 306A, 306B are configured to be controlled independently of the downstream actuation devices 380A, 380B.

As will be described, the adjustable bale forming chamber system 336 is for compressing newly-formed bales, to limit “spring-back”. The adjustable bale forming chamber housing 340 includes an interior element subsystem 348 (FIGS. 12A, 12B) with interior elements 350A, 350B which may be positioned parallel to each other, or non-parallel to each other. As a result, the interior elements 350A, 350B may be positioned in a wide variety of positions, thereby providing the operator with the ability to respond optimally to conditions, to minimize or reduce “spring-back”. The interior elements 350 each include a first interior element portion 355A and a second interior element portion 355B where the second interior element portion is hingedly connected to the frame and the first interior element and the second interior element portions are higendly connected to each other. The hinged connection between interior elements with the frame and the hinged connection between the interior element portions assist to maintain a spaced relationship between the interior elements as they move between the narrow and wide positions.

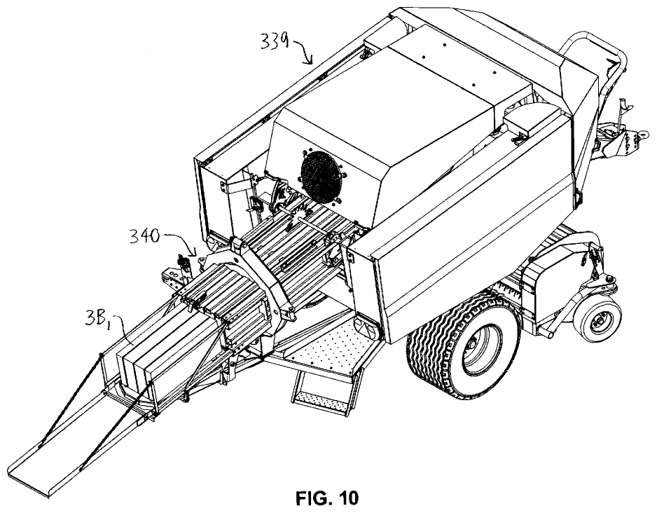

In FIG. 10, the adjustable bale forming chamber housing 340 is shown mounted to a baler 339. In one embodiment, the adjustable bale forming chamber housing 340 includes a frame 342 extending between a front end “3FE”, at which the bales are received in the adjustable bale forming chamber housing 340, and a back end “3BE” thereof, at which the bales exit the adjustable bale forming chamber housing 340 (FIGS. 12A, 12B). As can be seen in FIGS. 12A and 12B, the frame 342 has first and second sides “3FS”, “3SS”.

As can be seen in FIGS. 12A and 12B, the frame 342 includes top and bottom side members 343_{T}, 343_{B} that are at least partially held in place by transverse elements 345A, 345B of the frame 342. In the current embodiment, there are two top side members 343_{T}, one on each side of the frame 342, and two bottom side members 343_{B}, also one on each side of the frame 342. In one embodiment, the top and bottom side members 343_{T}, 343_{B} are welded to the downstream and upstream transverse members 345A, 345B although other methods of fastening or integrating these components may be contemplated.

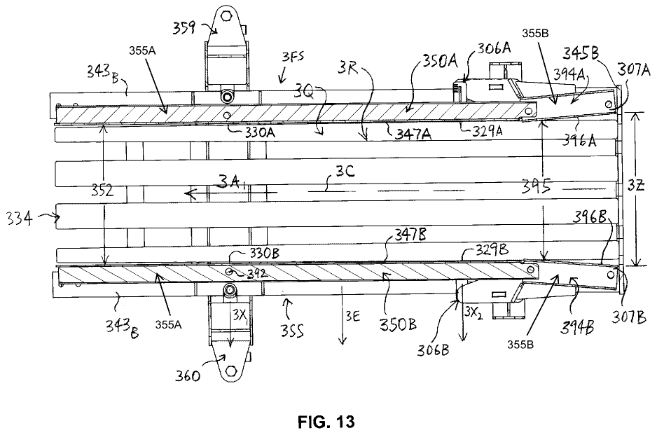

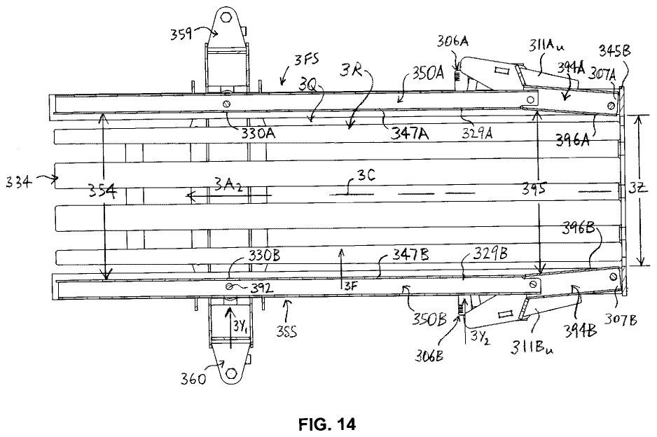

The interior elements 350A, 350B are movable, relative to the frame 342, between a narrow condition or position (FIG. 13) and a wide condition or position (FIG. 14). It will also be understood that the interior elements 350A, 350B may also be located in any intermediate condition between the narrow and wide conditions or positions. As noted above, the interior elements 350A, 350B may be positioned parallel to each other, or non-parallel to each other.

As can be seen in FIGS. 12A and 12B, the interior elements 350A, 350B are positioned between the top side member 343_{T} and the bottom side member 343_{B} of the frame 342, on each side of the housing 340. The interior elements 350A, 350B are movable laterally relative to the top and bottom side members 343_{T}, 343_{B} on each side of the housing 340, as will be described.

In one embodiment, the interior elements 350A, 350B include respective flat plates 347A, 347B that define a main channel “3Q” of the housing 340, through which the bales are moved (FIGS. 13, 14). The bales engage the plates 347A, 347B and are laterally compressed as the bales are moved through the main channel “3Q”. Depending on the positions of the interior elements 350A, 350B, the width of the channel defined therebetween varies.

When the interior element subsystem 348 is in its narrow condition of position, the interior elements 350A, 350B are positioned to locate the plates 347A, 347B to define the main channel “3Q” at its narrowest, so that the plates 347A, 347B are separated by a first distance 352 (FIG. 13). When the interior element subsystem 348 is in its wide condition or position, the interior elements 350A, 350B are positioned to locate the plates to define the main channel “3Q” at its widest, so that the plates 347A, 347B are separated by a second distance 354 (FIG. 14).

As can be seen in FIGS. 13 and 14, in one embodiment, the interior elements 350A, 350B are parallel to each other when defining the narrowest and widest widths 352, 354 of the main channel “3Q”. However, when the interior elements 350A, 350B are intermediate between their first and second positions, the interior elements 350A, 350B may be positioned parallel or non-parallel to each other. Accordingly, the channel “3Q” may be defined by the interior elements positioned either parallel or non-parallel to each other.

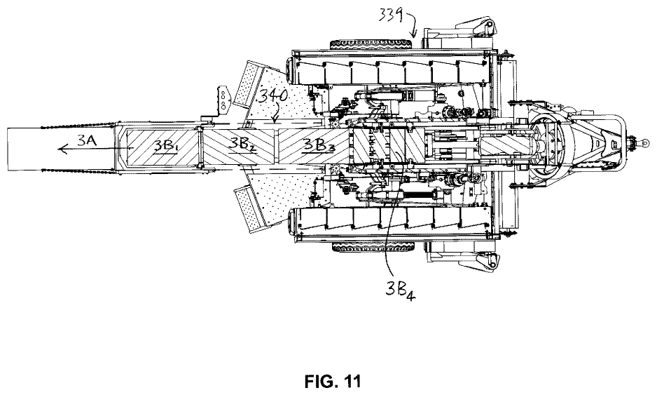

In operation, when the baler is producing bales, the bales are moved through the channel defined between the plates 347A, 347B connected to the first and second interior elements 350A, 350B in the directions indicated by arrows “3A₁” and “3A₂” in FIGS. 13 and 14 respectively. As each bale is formed in the baler 339 and pushed out of the baler 339 into the adjustable bale forming chamber housing 340, each such bale pushes against the bales already in the housing 340, ultimately pushing bales out at the back end “3BE” (FIG. 11). It will be understood that the outer sides of the frame 342 are represented by dashed lines in FIG. 11.

In FIG. 11, the bales “3B₁”, “3B₂”, and “3B₃” are pushed through the housing 340, in the direction indicated by arrow “3A”. The bale “3B₁” is also shown exiting the housing 340 in FIG. 10. It will also be understood that, as illustrated in FIG. 11, bale “3B₄” is being formed in the baler 339.

When the interior element subsystem 348 is in its narrow position, the interior elements 350A, 350B are in their respective first positions (FIG. 13). Similarly, when the interior element system 348 is in its wide position, the interior elements 350A, 350B are in their respective second positions (FIG. 14). The interior elements 350A, 350B may be positioned in any intermediate positions, between their respective first and second positions. As will be described, the interior elements 350A, 350B may be located parallel or non-parallel to each other, when in intermediate positions.

From the foregoing, it can be seen that the interior elements 350A, 350B may be positioned to define any selected intermediate channel width that is between the narrowest width (i.e., the width 352 of the channel in the first position) and the widest width (i.e., the width of 354 the channel in the second position), and that the interior elements 350A, 350B may or may not be parallel to each other when they are in any intermediate position.

In one embodiment, the housing 340 includes a top wall 332 and a bottom wall 334 that are mounted to the frame 342. In one embodiment, the bottom wall 334 is secured to the downstream and upstream transverse members 345A, 345B, and is not movable relative to the frame 342. The bottom wall or floor 334 supports the bales moving through the housing 340. As will be described, the top wall 332 is pivotably connected to the transverse element 345B at the front end “3FE” of the housing 340, so that a downstream end 331 of the top wall 332 is movable relative to the top side members 343_{T} at the back end “3BE” of the housing 340.

In summary, the interior elements 350A, 350B are positioned between the top and bottom side members 343_{T}, 343_{B}, and the interior elements 350A, 350B are laterally movable, while parallel or non-parallel to each other, relative to the top and bottom side members 343_{T}, 343_{B}. The interior elements 350A, 350B may be held parallel to a center line “3C” of the housing 340 while they move relative to the frame 342 (FIG. 13-15). However, the interior elements 350A, 350B may be non-parallel while they are moved relative to the frame 342.

Those skilled in the art would appreciate that the top wall 332 and the bottom wall 334 may be formed of any suitable components. In one embodiment, as shown in FIGS. 12A and 12B, the top wall 332 is formed of suitable tubes or members, e.g., steel tubes and/or members. For clarity of illustration, the tubes that form the top wall 332 are individually identified by reference characters 332-1 to 332-4 inclusive in FIG. 12A.

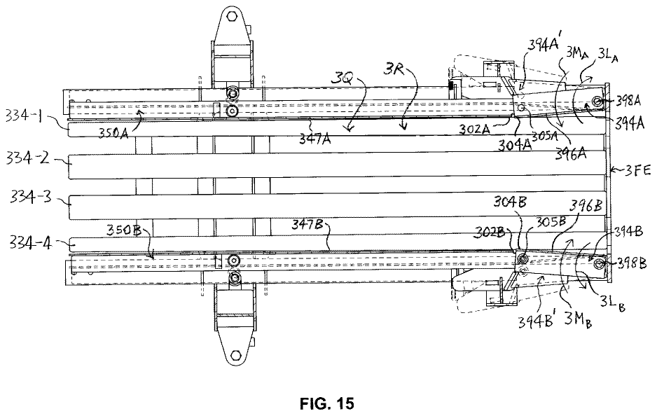

As can be seen in FIG. 12A, the bottom wall 334 is formed of a number of parallel floor elements. The floor elements that form the bottom wall 334 are individually identified by reference characters 334-1 to 334-4 in FIG. 15. Each of the floor elements includes a supporting tube 351 and a floor plate 353 positioned on the supporting tube 351. Other examples may include, but are not limited to, a tube, a plate or a channel or a combination of these examples.

As can also be seen in FIGS. 12A and 12B, the interior elements 350A, 350B include the substantially flat plates 347A, 347B for defining the main channel “3Q” and engaging the sides of the bales, as the bales move through the main channel “3Q”. In one embodiment, as can be seen in FIGS. 12A and 12B, the interior elements 350A, 350B also include respective upper and lower ribs 349Aᵤ, 349Bᵤ, 349A_{L}, and 349B_{L}, to support the plates 347A, 347B. Those skilled in the art would appreciate that the plates 347A, 347B are sufficiently smooth to allow the bales to be squeezed therebetween while the bales are moving through the channel.

From the foregoing, it can be seen that the interior elements 350A, 350B are movable between their respective first and second positions relative to the frame 342.

The interior elements 350A, 350B are positionable to define channels that have widths varying between a minimum or narrow width and a maximum or wide width. When the interior element subsystem 348 is in the narrow and wide positions thereof, the interior elements 350A, 350B define the minimum or first width and the maximum or second width respectively.

A large difference in minimum (narrow) and maximum (wide) widths of the channel is believed to be advantageous, because it enables the operator to adjust the channel width to be the optimum, based on the prevailing conditions as outlined above.

As noted above, the interior elements 350A, 350B may be positioned non-parallel to each other, or parallel. In addition to determining an optimum or preferred width, the operator may select a preferred configuration, in which the interior elements 350A, 350B may be parallel, or non-parallel with each other. If the operator chooses a non-parallel configuration, then the operator also determines the extent to which the interior elements are not parallel, given the current prevailing conditions. Those skilled in the art would appreciate that conditions may change significantly from one day to the next, or during one day, requiring adjustment to define an optimum or updated configuration of the interior elements 350A, 350B.

When the interior elements 350A, 350B are positioned as required (i.e., according to instructions by the operator based on the current conditions), the bales moving through the channel therebetween are squeezed or compressed laterally between the plates 247A, 247B connected to the interior elements 350A, 350B along the entire respective lengths of the plates 347A, 347B. The interior elements 350A, 350B are positioned to compress the sides of the bales, via the plates, to an optimum or preferred extent, based on prevailing conditions. As noted above, the plates 347A, 347B are smooth, to facilitate movement of the bales through the channel while the bales are laterally compressed (i.e., compressed at the sides thereof).

When the interior elements 350A, 350B are parallel, the lateral compression to which the bales are subjected is substantially constant, while the bales move through the channel. When the interior elements 350A, 350B are positioned non-parallel to each other, the lateral pressure to which the bales are subjected may gradually increase (or decrease, as the case may be), as the bales move through the channel.

Because the lateral compression is limited in its extent, and because the bales are subjected to the lateral compression between the plates 347A, 347B for an extended period of time before they are released from the housing 340, the bales tend to remain at least partially laterally compressed after exiting the housing 340. Accordingly, the system of the disclosure minimizes or reduces “spring-back”.

As noted above, the actuation subsystem 338 includes the downstream actuation devices 380A, 380B that also are mounted to connect the interior elements 350A, 350B and the frame 342.

As can be seen in FIGS. 12A-14, the frame 342 includes first and second platforms 359, 360 that are secured to the downstream transverse element 345A and mounted at the first and second sides “3FS”, “3SS” of the frame 342 respectively. The downstream actuation devices 380A, 380B are mounted at the respective first and second downstream platforms 359, 360. The first and second platforms 359, 360 are located downstream (relative to the direction of travel of the bales through the channel) from the upstream actuation devices 306A, 306B (FIGS. 12A, 12B). As will be described, the upstream actuation devices 306A, 306B are partially mounted to respective intake assemblies 394A, 394B (FIGS. 12A, 12B)

The first and second downstream actuation devices 380A, 380B and the first and second upstream actuation devices 306A, 306B are configured for moving the interior element subsystem 348 between the narrow and wide positions thereof. The first and second downstream actuation devices 380A, 380B are connected to the first and second interior elements 350A, 350B respectively, and also to the frame 342, at each side “3FS”, “3SS” thereof respectively. In some embodiments. the first and second downstream actuation devices 380A, 380B are identical in all relevant respects, except that they are positioned to be mirror images of each other. To simplify the description, only the second downstream actuation device 380B and its connections to the frame 342 and the interior element 350B are described in detail, however, it is understood that operation of the first downstream actuation device 380A and its connection to the frame 342 and interior element 350A function in a similar or identical manner.

The first and second upstream actuation devices 306A, 306B are also connected to the first and second interior elements 350A, 350B respectively, and also to the intake assemblies 394A, 394B, at each side “3FS”, “3SS” thereof respectively. The first and second upstream actuation devices 306A, 306B are identical in all relevant respects, except that they are positioned to be mirror images of each other.

The actuation devices may be any suitable devices. In one embodiment, as illustrated, the downstream actuation devices 380A, 380B are hydraulic cylinders (FIGS. 12A-12B). The actuation devices may also be manual or dynamic actuation devices.

As schematically illustrated in FIG. 9, the actuation subsystem 338 includes a controller 382 for controlling the downstream actuation devices 380A, 380B. As will be described, via the controller 382, the downstream hydraulic cylinders 380A, 380B are activated and de-activated simultaneously, to result in simultaneous (or substantially simultaneous) corresponding parallel or non-parallel movements of the interior elements 350A, 350B.

However, those skilled in the art would appreciate that the controller 382 is optional. In some embodiments, the actuation devices may be controlled or manipulated manually to position the connected interior elements such that the plates define the desired width for the channel where the bales pass through.

In one embodiment, the actuation subsystem 338 may, for example, include only the downstream and upstream actuation devices 380A, 380B, 306A, and 306B. In the absence of a controller that is configured for controlling the pair of downstream actuation devices or the pair of upstream actuation devices for simultaneous movement, the actuation devices may be activated independently for corresponding movement that is not simultaneous.

In the embodiment illustrated in FIGS. 9-16, the upstream actuation devices 306A, 306B are activated independently.

Those skilled in the art would appreciate that the controller 382, if included in the subsystem 338, may be any device that is suitable for controlling some or all of the actuation devices and may be located in any suitable location. For instance, the controller may be located in the cab of a tractor (not shown) that tows the baler 339 such that it is accessible by an operator. Also, it will be understood that the controller 382 may be configured in any suitable way, e.g. for automatic operation of the system, and/or manual operation thereof.

The second hydraulic cylinder 380B is connected to the interior element 350B and to the second side “3SS” of the frame 342 (i.e., via the downstream transverse element 345A). The second platform 360, which is included in the transverse member 345A and thereby secured to the frame 342, includes upper and lower plates 383, 384 inside which the second hydraulic cylinder 380B is mounted (FIG. 12A). A pin 385 extends between the plates 383, 384 and is outlined in dashed lines in FIG. 12A.

The hydraulic cylinder 380B includes a cylinder body 386 (FIGS. 12A, 12B). It will be understood that the hydraulic cylinder 380A is mounted to the frame 342 and to the interior element 350B in the same manner as the hydraulic cylinder 380B is mounted to the frame 342 and to the interior element 350B, described above.

Those skilled in the art would appreciate that a piston (not shown) is located within the hydraulic cylinder body 386 and a rod (not shown) that is connected to the piston extends from the body. The hydraulic cylinder 380B is pivotably connected, at an inner end of the rod, to a pin 392 (FIGS. 13, 14) that is secured to the interior element 350B. In some embodiments, the hydraulic cylinder 380B includes a bushing (not shown) mounted at the end of the rod that fits around the pin. Accordingly, the hydraulic cylinder is, via its pivotable connection to the pin at the hydraulic cylinder's inner end, connected to the interior element 350B.

At an outer end of the hydraulic cylinder 380B, the hydraulic cylinder 380B includes a bushing 387 that is connected to the pin 385 (FIG. 12A). The plates 383, 384 are included in the downstream transverse element 345A, and the pin 385 extends between the plates 383, 384. Accordingly, the hydraulic cylinder 380B is, via its pivotable connection to the pin 385, connected to the frame 342.

It will be understood that a number of elements are omitted from FIGS. 12A-16 for clarity of illustration.

As shown in FIG. 13, movement of the rod of the hydraulic cylinder 380B from the extended condition thereof to the retracted condition thereof is in the direction indicated by arrow “3X₁”. Similarly, in FIG. 14, movement of the rod of the hydraulic cylinder 380B from the retracted condition to the extended condition thereof is in the direction indicated by arrow “3Y₁”.

When the hydraulic cylinder 380B is in its extended condition, the interior element 350B is in its first position, at the downstream location 330B thereon (FIG. 13). Upon the hydraulic cylinder 380B moving from its extended condition to its retracted condition, the rod thereof moves in the direction indicated by arrow “3X₁”, causing the interior element 350B, at the downstream location 330B thereon, to move in the direction indicated by arrow “3E”, toward its second position (FIG. 13).

As indicated in FIG. 14, when the hydraulic cylinder 380B is in its retracted condition, the interior element 350B is in its second position, at the downstream location 330B thereon. Upon the hydraulic cylinder 380B moving from its retracted condition to its extended condition, the rod thereof moves in the direction indicated by arrow “3Y₁”, causing the interior element 350B, at the downstream location 330B thereon, to move in the direction indicated by arrow “3F”, toward its first position (FIG. 14).

In one embodiment, the upstream actuation devices 306A, 306B include respective bolts 308A, 308B (FIGS. 12A, 12B).

As can be seen in FIG. 12A, the upstream mount 362 includes an outer plate 309B held between upper and lower brackets 311Bᵤ, 311B_{L}. The upper and lower brackets 311Bᵤ, 311B_{L} are secured to the panel assembly 394B (FIG. 12A), e.g., by welding although other methods of fastening may be contemplated.

It will be understood that an outer end of the bolt 308B is rotatable in the outer plate 309B. The upstream adjustment assembly 306B also includes an inner fitting 313B in which an inner end of the bolt 308B is threadably engaged. The inner fitting 313B is secured to the interior element 350b (FIG. 12A).

From the foregoing, it can be seen that rotating the bolt 308B in the appropriate direction (e.g., clockwise) causes the inner fitting 313B, and therefore also the interior element 350B at the inner fitting 313B, to move in the direction indicated by arrow “3X₂” in FIG. 13. Similarly, rotating the bolt 308B in a counterclockwise direction causes the inner fitting 313B, and therefore also the interior element 350B at the inner fitting 313B, to move in the direction indicated by arrow “3Y₂” in FIG. 14.

In the embodiment illustrated, rotation of the bolt 308B may cause the distance between the outer plate 309B and the inner fitting 313B to increase or decrease, depending on the direction of rotation. Those skilled in the art would appreciate that a wide variety of actuation devices may be used to position the inner fitting 313B as required relative to the outer plate 309B.

It will be understood that the other upstream actuation device 306A is a mirror image of the upstream actuation device 306B. Upper and lower brackets 311Aᵤ, 311A_{L} and an outer plate 309A and a bolt 308A are shown in FIG. 12B.

As can be seen in FIGS. 12A and 12B, the actuation devices 306A, 306B are independently activated. For example, in use, the operator may locate the bolt in the actuation device 306A to position the inner fitting to which the device 306A is threadably engaged (not shown) as required, and within a short while thereafter, the operator may locate the bolt 309B in the actuation device 306B to position the inner fitting 313B in a corresponding position relative to the outer plate 309B.

In an alternative embodiment, with suitable upstream actuation devices (e.g., electric motors, or hydraulic cylinders), the upstream actuation devices may be controlled for simultaneous corresponding movement.

As can be seen in FIGS. 13 and 14, respective downstream locations 330A, 330B on the plates 347A, 347B are opposite to the points on the interior elements 350A, 350B at which the respective downstream actuation elements 380A, 380B are connected thereto. Similarly, respective upstream locations 329A, 329B on the plates 347A, 347B are opposite to the points on the interior elements 350A, 350B at which the upstream actuation elements 306A, 306B are connected thereto, at the inner fittings 313A, 313B thereof.

In one embodiment, the hydraulic cylinder 380B is activated by the controller 382, to cause the rod thereof to be moved between an extended condition and a retracted condition, and the other hydraulic cylinder 380A is also correspondingly activated by the controller 382, at the same time, for corresponding movement of the rod thereof. The hydraulic cylinders 380A, 380B are controlled to have corresponding movements of their respective rods (i.e., in opposite directions) at the same time, or at substantially the same time. That is, the rods of the respective hydraulic cylinders 380A, 380B are both moved outwardly at the same rate, and to the same extent, at the same time, or at substantially the same time. Also, the rods of the respective hydraulic cylinders 380A, 380B are both moved inwardly at the same rate, and to the same extent, at the same time, or at substantially the same time.

The result is that, at the downstream locations 330A, 330B thereon, the plates 347A, 347B are located equidistant from the center line “3C”, regardless of whether the interior elements 350A, 350B are in their respective first positions, second positions, or any intermediate positions therebetween.

As can be seen in FIGS. 12A-15, in one embodiment, the adjustable bale forming chamber housing 340 includes the first side and second side intake assemblies 394A, 394B, which are generally positioned between the front end “3FE” of the frame 342 and the respective interior elements 350A, 350B. The intake assemblies 394A, 394B include respective intake panels 396A, 396B (FIGS. 13, 14). As will be described, the intake assemblies 394A, 394B are formed for positioning the intake panels 396A, 396B to define an intake channel 395 therebetween. The intake channel guides the bales entering the housing 340 toward the channel, in which the bales slidingly engage the plates 347A, 347B of the interior elements 350A, 350B as the bales move through the housing 340 (FIG. 15). The channel commences at the upstream ends 302A, 302B of the interior elements 350A, 350B.

Because the interior elements 350A, 350B are movable between first and second positions thereof (as described above), the intake assemblies 394A, 394B are pivotably movable when the interior elements 350A, 350B are moved, as will be described. As will also be described, because of the pivoting movement of the intake assemblies 394A, 394B, the width of the intake channel 395 may be changed, depending on the positions of the intake assemblies 394A, 394B.

The intake channel 395 and the main channel “3Q” collectively form an exit housing channel “3R” that extends between the front end “3FE” and the back end 3“BE” of the housing 340 (FIGS. 12A-15). As noted above, the width of the main channel “3Q” may be adjusted by the operator to take changes in current conditions into account, and the width of the intake channel at its downstream end varies with changes in the width of the main channel “3Q”. The width of the main channel “3Q” may be optimized (i.e., adjusted) as required, and the intake channel 395 is formed to guide or direct the bales into the upstream end of the main channel “3Q”, even though the width of the main channel “3Q” varies.

In FIG. 15, the interior elements 350A, 350B that are in their respective first positions, and the intake assemblies positioned accordingly, are shown in solid outlines. The interior elements 350A, 350B that are in their respective second positions are shown in dashed outlines, for clarity of illustration. The intake assemblies that are shown connected with the interior assemblies in their second positions are also shown in dashed outlines and are identified in FIG. 15 by reference characters 394A′, 394B′.

The intake assemblies 394A, 394B are pivotably connected with the frame 342 at respective upstream ends 307A, 307B (FIGS. 13-14) thereof at the front end “3FE” by respective pins 398A, 398B (FIGS. 12A-15), and they are also pivotably connected with the interior elements 350A, 350B at upstream ends 302A, 302B of the interior elements 350A, 350B, by respective brackets on the upstream ends 302A, 302B (FIG. 15). It will be understood that the brackets are omitted from FIG. 15 for clarity of illustration. In some embodiments, the brackets extend over the intake assemblies 394A, 394B, and the intake assemblies 394A, 394B are pivotably connected, at downstream ends 304A, 304B thereof, with the brackets 303A, 303B by respective pins 305A, 305B (FIG. 15).

Due to the pivotable connections of the respective downstream ends 304A, 304B of the intake assemblies 394A, 394B with the respective upstream ends 302A, 302B of the interior elements 350A, 350B, the downstream ends 304A, 304B move laterally with the respective interior elements 350A, 350B to which the downstream ends 304A, 304B are respectively connected. However, because the upstream ends 307A, 307B of the intake assemblies 394A, 394B are pivotably connected to the frame 342 at the front end “3FE”, the intake assemblies 394A, 394B pivot about the pins 398A, 398B when the downstream ends 304A, 304B move with the respective interior elements 350A, 350B.

For example, when the interior elements 350A, 350B are moved outwardly (i.e., from their respective first positions toward the second positions thereof), the downstream ends 304A, 304B of the intake assemblies 394A, 394B pivot about the pins 398A, 398B as indicated by arrows “3L_{A}”, “3L_{B}” (FIG. 15), because the downstream ends 304A, 304B are pulled outwardly when the interior elements 350A, 350B move toward the second positions thereof. Similarly, when the interior elements 350A, 350B are moved inwardly (i.e., from their respective second positions toward the first positions thereof), the downstream ends 304A, 304B of the intake assemblies 394A, 394B pivot about the pins 398A, 398B as indicated by arrows “3M_{A}”, “3M_{B}” (FIG. 15), because the downstream ends 304A, 304B are pushed inwardly when the interior elements 350A, 350B move toward the first positions thereof. Accordingly, the downstream ends 304A, 304B of the intake assemblies 394A, 394B move with the interior elements 350A, 350B, when the interior elements 350A, 350B are moved between their respective first and second positions.

From the foregoing, it can be seen that because the downstream ends 304A, 304B are proximal to the plates 347A, 347B at the upstream ends 302A, 302B of the interior elements 350A, 350B, the bales are smoothly guided by the intake panels 396A, 396B shortly after the bales enter the bale forming chamber housing 340 to enter the channel, where they engage the plates 347A, 347B.

In FIGS. 14-16, it can be seen that the width of the intake channel 395 varies from its upstream end to its downstream end, i.e., along the length of the intake channel 395, from the upstream ends 307A, 307B to the downstream ends 304A, 304B of the intake assemblies 394A, 394B. At the upstream end of the intake channel 395, i.e., between the upstream ends 307A, 307B of the intake assemblies 394A, 394B, the intake channel 395 is at its widest, i.e., the width thereof at that point is the distance “3Z” (FIGS. 13, 14, 16). In addition, because the positions of the downstream ends 304A, 304B of the intake assemblies 394A, 394B relative to the frame 342 change with movement of the upstream ends 302A, 302B of the interior elements 350A, 350B, the intake channel's width is subject to change, except at its upstream end, i.e., between the upstream ends 307A, 307B of the intake assemblies 394A, 394B.

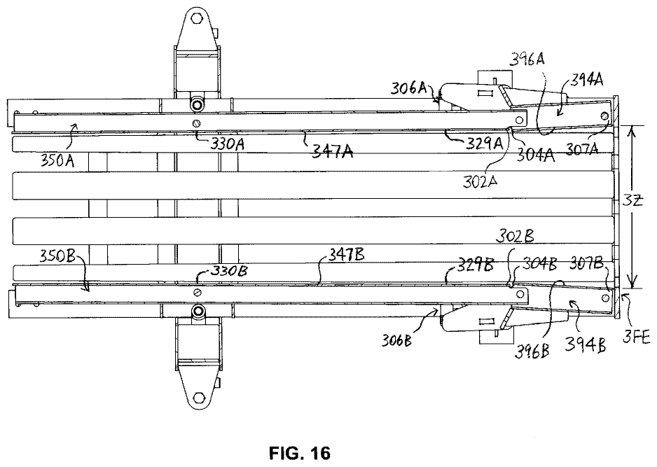

In FIG. 16, the interior elements 350A, 350B are shown positioned in non-parallel positions relative to each other, to provide an example of circumstances in which such positions may be advantageous.

In the example illustrated in FIG. 16, the channel is approximately 16 ½ inches wide, at the downstream locations 330A, 330B on the plates 347A, 347B. At the upstream locations 329A, 329B, the upstream actuation devices 306A, 306B have been activated to position the plates 347A, 347B at the upstream locations 329A, 329B approximately 17 inches apart. Accordingly, as illustrated in FIG. 16, the interior elements 350A, 350B are non-parallel.

As can be seen in FIG. 16, due to the relatively narrow channel at the downstream locations 330A, 330B, when the interior elements 350A, 350B are moved to their respective positions to define the channel at the downstream locations 330A, 330B, a somewhat less narrow channel is defined between the upstream locations 329A, 329B. When the upstream actuation devices 306A, 306B are activated to position the upstream locations 329A, 329B as shown, the downstream ends 304A, 304B of the intake panels 394A, 394B of the intake assemblies are pulled by the interior elements 350A, 350B to define an opening between the intake panels 396A, 396B proximal to the upstream ends 302A, 302B of the interior elements 350A, 350B that is wider than the narrow channel between the downstream locations 330A, 330B.

The net result is that the bales entering the channel (i.e., at the upstream ends 302A, 302B) are laterally compressed somewhat less than they would have been at that point if, for example, the interior elements 350A, 350B had been moved parallel to each other to define a narrow channel that is the same width (e.g., approximately 16.5 inches) along its length. Depending on the conditions, the flexibility that the independent pairs of actuation devices provides the operator may be important in practice. For instance, an application of gradually increasing laterally directed compression, which would occur as the bales are moved through the tapered channel illustrated in FIG. 16, may be more effective in limiting “spring-back” than an application of the same laterally directed compression along the entire length of the channel.

As can be seen in FIG. 16, at the front end “3FE”, the upstream ends 307A, 307B of the intake assemblies 394A, 394B define a relatively wide intake opening “3Z” to the intake channel 395. As noted above, movement of the interior elements 350A, 350B inwardly causes the downstream ends 304A, 304B of the intake assemblies 394A, 394B to move inwardly.

However, because the upstream actuation devices 306A, 306B are configured to operate independently of the downstream actuation devices 380A, 380B, the upstream actuation devices 306A, 306B may be activated to move the interior elements 350A, 350B to define a selected width of the channel between the upstream locations 329A, 329B on the plates 347A, 347B. It will be understood that the width of the channel between the two upstream locations 329A, 329B may be selected in view of the width between the downstream location 330A, 330B to provide an optimum or preferred non-parallel configuration. For instance, in the example illustrated in FIG. 16, such width may be selected to provide a somewhat wider channel between the upstream locations 329A, 329B than the channel that is defined between the locations 330A, 330B.

In the example illustrated in FIG. 16, the result is that the plates 347A, 347B define a channel that gradually narrows, proceeding in a downstream direction, from the channel between the upstream locations 329A, 329B to the channel between the downstream locations 330A, 330B. Accordingly, in this example, the slightly wider channel at the upstream locations 329A, 329B provides a gradual transition from the relatively wide upstream opening “3Z” to the relatively narrow channel at the downstream locations 330A, 330B. The gradual transition is believed to result in better productivity, because the bales are less likely to bind when entering into and/or moving through a channel tapered in the downstream direction from a wider to a narrower width thereof.

From the foregoing, it can be seen that the interior elements 350A, 350B may be positioned in any suitable non-parallel arrangement. For example, the interior elements 350A, 350B may be positioned to locate the downstream points 330A, 330B on the plates 347A, 347B closer together than the upstream points 329A, 329B, so that the main channel “3Q” narrows in a downstream direction, i.e., in the direction of travel of the bales. Alternatively, if it is thought to be more likely to minimize “spring-back”, then the downstream points 330A, 330B may be positioned further apart from each other than the upstream points 329A, 329B.

Because the intake assemblies 394A, 394B are pivotably connected at their downstream ends 304A, 304B to the upstream ends 302A, 302B of the interior elements 350A, 350B, the width of the intake channel 395 defined thereby changes, at its downstream end (i.e., between the downstream ends 304A, 304B), with changes in the positions of the upstream ends 302A, 302B.

As its upstream end (i.e., between the upstream ends 307A, 307B of the intake assemblies 394A, 394B), the width of the intake channel 395 is fixed, i.e., it is the relatively wide distance “3Z”. The distance “3Z” is relatively large, so that bales entering the intake channel 395 will encounter relatively little resistance or drag from the intake assemblies 394A, 394B when entering the intake channel 395. As noted above, once the bales are in the intake channel 395, they are smoothly guided thereby to the main channel “3Q”. Due to the funnel-shaped configuration of the intake channel 395 and the smooth transition therefrom to the main channel “3Q”, the bales move through the housing channel “3R” from the front end “3FE” to the back end “3BE” with minimal disruption. As a result, due to adjustments made to take prevailing conditions into account, the system 336 subjects the bales to the desired compression to minimize “spring-back” without adversely affecting productivity.

As can be seen in FIG. 12A, in one embodiment, the top wall 332 is pivotably connected to the frame 342 by a hinge assembly 397 located proximal to the front end “3FE” of the frame 342. It is also preferred that, at a downstream location, a bracket 333 secures the members 332-1, 332-2, 332-3, and 332-4 of the top wall 332 together.

An actuation device 335 connects the bracket 333 and the transverse element 345A together.

From the foregoing, it can be seen that the actuation device 335 may be controlled via a controller (not shown), e.g., by the operator, to raise or lower a downstream end 331 of the top wall 332 relative to the top side members 343_{T}, as required. Those skilled in the art would appreciate that the operator may position the downstream end 331 of the top walls 332 to take the then current conditions into account, for instance, to press downwardly onto a top side of the bale, if required, and to the extent required.

It will be appreciated by those skilled in the art that the invention can take many forms, and that such forms are within the scope of the invention as claimed. The scope of the claims should not be limited by the preferred embodiments set forth in the examples, but should be given the broadest interpretation consistent with the description as a whole.

We claim:

1. An adjustable bale forming chamber housing system for compressing bales, the adjustable bale forming chamber housing comprising:
a frame extending between a front end at which the bales are received in the adjustable bale forming chamber housing and a back end at which the bales exit the adjustable bale forming chamber housing;
an interior element subsystem comprising:
a pair of interior elements defining a channel, the pair of interior elements movable between a narrow position, in which a narrow channel is at least partially defined between the interior elements, and a wide position, in which a wide channel is at least partially defined between the interior elements;
wherein each of the interior elements includes a first interior element portion and a second interior element portion;
wherein the second interior element portion is hingedly connected to the frame and the first interior element portion is hingedly connected to the second interior element portion; and
an actuation subsystem, for moving the interior elements between the narrow position and the wide position.

2. The adjustable bale forming chamber housing system of claim 1 wherein the actuation subsystem moves the pair of interior elements parallel or somewhat parallel to each other.

3. The adjustable bale forming chamber housing system of claim 1 wherein the actuation subsystem comprises separate actuators for each of the pair of interior elements to move the interior elements and to maintain a spacing relationship between the pair of interior elements.

4. The adjustable bale forming chamber housing of claim 3 wherein the actuation subsystem further comprises separate actuators for each of the first interior element portions and second interior element portions of the pair of interior elements.

5. The adjustable bale forming chamber housing system of claim 1 wherein each of the
first interior element portions is attached to a plate.

6. The adjustable bale forming chamber housing system of claim 3 wherein the actuation devices are mounted to the adjustable bale forming chamber housing.

7. The adjustable bale forming chamber housing system of claim 6 wherein the actuation system further comprises a controller for controlling the actuation devices.

8. The adjustable bale forming chamber housing system of claim 7 wherein the set of actuation devices comprises:
a set of upstream actuation devices; and
a set of downstream actuation devices.

9. The adjustable bale forming chamber housing system of claim 1 wherein the actuation subsystem maintains a parallel relationship between the pair of interior elements.

10. The adjustable bale forming chamber housing system of claim 1 further comprising an apparatus for mounting the adjustable bale forming chamber housing system to a baler.

11. The adjustable bale forming chamber housing system of claim 6 wherein the actuation devices are hydraulic cylinders, manual actuation devices or dynamic actuation devices.

12. The adjustable bale forming chamber housing system of claim 1 further comprising:
an intake assembly connected to the pair of interior elements for guiding the bales received at the front end towards the channel.

13. The adjustable bale forming chamber housing system of claim 12 wherein the intake assembly is integrated with the second interior element portions of the pair of interior elements.

14. The adjustable bale forming chamber housing system of claim 1 further comprising a linkage assembly for maintaining the parallel relationship between the pair of interior elements.

15. The adjustable bale forming chamber housing system of claim 14 wherein the linkage assembly comprises a linkage subassembly connected to each of the pair of interior elements.
